(19) United States
(12) Patent Application Publication
(10) Pub. No.: US 2015/0118672 A1
(43) Pub. Date: Apr. 30, 2015

(54) SYSTEM AND METHOD FOR LEARNING MANAGEMENT

(71) Applicant: Google Inc., Mountain View, CA (US)

(72) Inventors: Zachary Yeskel, Brooklyn, NY (US); Kara Ann Levy, New York, NY (US); James Michael McCollum, Brooklyn, NY (US); Vance Vagell, Kew Gardens, NY (US); Cinthya Mohr, New York, NY (US); Shoshana Holtzblatt, New York, NY (US); Tamara Olson, Long Island City, NY (US)

(73) Assignee: Google Inc., Mountain View, CA (US)

(21) Appl. No.: 14/101,793

(22) Filed: Dec. 10, 2013

Related U.S. Application Data
(60) Provisional application No. 61/895,096, filed on Oct. 24, 2013.

(51) Int. Cl. G09B 5/00

(52) U.S. Cl. CPC G09B 5/00
USPC 434/362

(57) ABSTRACT

A method includes receiving, at one or more server computers, an assignment creation request from a leader user account. The assignment creation request identifies a document that is stored at a storage system, identifies a plurality of participant user accounts, and causes creation of an assignment at the one or more server computers. The method also includes storing, at the storage system, a respective copy of the document for each participant user account, wherein an ownership parameter for each respective copy of the document references a respective participant user account from the plurality of participant user accounts.

### CROSS-REFERENCE TO RELATED APPLICATIONS

This application claims the benefit of U.S. Provisional Patent Application Ser. No. 61/895,096, which was filed on Oct. 24, 2013.

### BACKGROUND

The disclosure herein relates generally to systems and methods for learning management.

Computer systems are known that allow for shared access to objects. As one example, shared storage systems users to create or store objects such as files at a remote server, access the files via a network such as the internet, grant shared access to the files to other users, and in some examples, edit the file using a file creation and editing system that is associated with the shared storage system.

In recent years, educational institutions have adopted web-based shared storage systems for use in classroom environments. Students are able to complete assignments by creating and editing a document using a web-based document creation and editing system, and then storing the document at the associated storage system. In order to submit the assignment for grading, the student might email the document to their teacher, or grant shared access to the document to their teacher.

### SUMMARY

The disclosure relates to systems and methods for learning management.

One aspect of the disclosed embodiments is a method that includes receiving, at one or more server computers, an assignment creation request from a leader user account. The assignment creation request identifies a document that is stored at a storage system, identifies a plurality of participant user accounts, and causes creation of an assignment at the one or more server computers. The method also includes storing, at the storage system, a respective copy of the document for each participant user account, wherein an ownership parameter for each respective copy of the document references a respective participant user account from the plurality of participant user accounts.

Another aspect of the disclosed embodiments is a method that includes receiving, at one or more server computers, an assignment creation request from a leader user account. The assignment creation request identifies an object and causes creation of an assignment at the one or more server computers. The method also includes monitoring, by the one or more server computers, one or more actions taken by each participant user account with respect to the object. The method also includes transmitting, by the one or more server computers, a notification to the leader user account, wherein the notification relates to at least one action from the one or more actions and at least one participant account from the plurality of participant accounts.

Another aspect of the disclosed embodiments is a method that includes receiving, from a first user, a request to open a document at a document editing system; outputting, for display, the document by the documents editing system, and determining whether the document is associated with at least one task assigned by at least one other user. If the document is associated with the at least one task assigned by the at least one other user, the method includes outputting for display with the document, an interface element that, when activated by the first user, causes a notification regarding the document to be sent to the at least one other user.

### BRIEF DESCRIPTION OF THE DRAWINGS

The description herein makes reference to the accompanying drawings wherein like reference numerals refer to like parts throughout the several views, and wherein:

FIG. 1 is a block diagram showing an example of an environment in which systems and methods for learning management can be implemented;

FIG. 2 is a block diagram showing an example of a hardware configuration for a server computer;

FIG. 3 is a block diagram showing a learning management system and a plurality of shared access systems;

FIG. 4 is an illustration showing an example of an interface screens that can be output for display by the learning management system;

FIG. 5 is an illustration showing an example of an interface screens that can be output for display by the learning management system;

FIG. 6 is an illustration showing an example of an interface screens that can be output for display by the learning management system;

FIG. 7 is an illustration showing an example of an interface screens that can be output for display by the learning management system;

FIG. 8 is an illustration showing an example of an interface screens that can be output for display by the learning management system;

FIG. 9 is an illustration showing an example of an interface screens that can be output for display by the learning management system;

FIG. 10 is an illustration showing an example of an interface screens that can be output for display by the learning management system;

FIG. 11 is an illustration showing an example of an interface screens that can be output for display by the learning management system;

FIG. 12 is an illustration showing an example of an interface screens that can be output for display by the learning management system;

FIG. 13 is an illustration showing an example of an interface screens that can be output for display by the learning management system;

FIG. 14 is an illustration showing an example of an interface screens that can be output for display by the learning management system;

FIG. 15 is a flowchart showing a first example of a process for learning management;

FIG. 16 is a flowchart showing a second example of a process for learning management;

FIG. 17 is a flowchart showing a third example of a process for learning management; and

FIG. 18 is a flowchart showing a fourth example of a process for learning management.

### DETAILED DESCRIPTION

Systems and methods for learning management are described herein. Although web-based shared storage systems have been adopted for classroom use, existing systems are not well-tailored to the particular needs of students and teacher. The systems and methods discussed herein are directed toward improvements in learning management that reduce teacher workload and enhance the user experience for shared storage systems in a classroom setting for both students and teachers.

The systems and methods discussed herein are applicable to management of an activity that is facilitated by a leader and undertaken by participants. The systems and methods are described herein with reference to an educational class as an example of an activity, where the leader is a teacher and the participants are students. The systems and methods described herein can, however, be adapted to facilitate other types of activities where the users of the system have different roles.

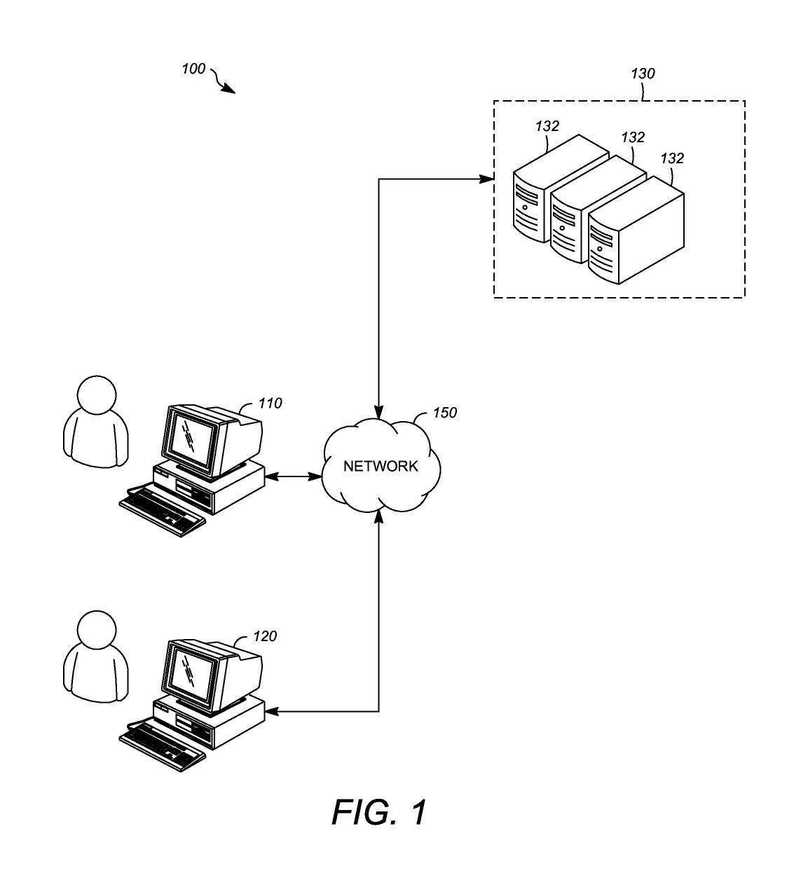

FIG. 1 shows an example of an environment 100 in which a systems and methods for managing learning can be implemented. The environment 100 can include a user system 110, one or more additional user systems 120, and an application hosting service 130. The user system 110 and the additional user systems 120 are each representative of a large number (e.g. millions) of systems that can be included in the environment 100, with each system being able to utilize one or more applications that are provided by the application hosting service 130. The user system 110 and the additional user systems 120 can each be any manner of computer or computing device, such as a desktop computer, a laptop computer, a tablet computer, or a smart-phone (a computationally-enabled mobile telephone). The application hosting service 130 can be implemented using one or more server computers 132. The user system 110, the additional user systems 120, and the application hosting service 130 can each be implemented as a single system, multiple systems, distributed systems, or in any other form.

The systems, services, servers, and other computing devices described herein are in communication via a network 150. The network 150 can be one or more communications networks of any suitable type in any combination, including wireless networks, wired networks, local area networks, wide area networks, cellular data networks, and the internet.

The application hosting service 130 can provide access to one or more hosted applications to a defined group of users including operators associated with the user system 110 and the additional user systems 120. As used herein, a shared workspace is any manner of system, program, or interface that allows a defined group of users to utilize an access-restricted system in which information can be shared between users for the purpose of collaboratively working on a project. As will be discussed herein, shared workspaces can implement document storage functions, document creation and editing functions, messaging functions, discussion functions, event scheduling functions, and task tracking functions. In some implementations, the application hosting service 130 allows a particular shared workspace to be accessed upon presentation of a credential, such as a username and password combination, that are associated with a registered user of that particular shared workspace. In some implementations, one or more users of each shared workspace are able to grant access to additional users or revoke access from existing users.

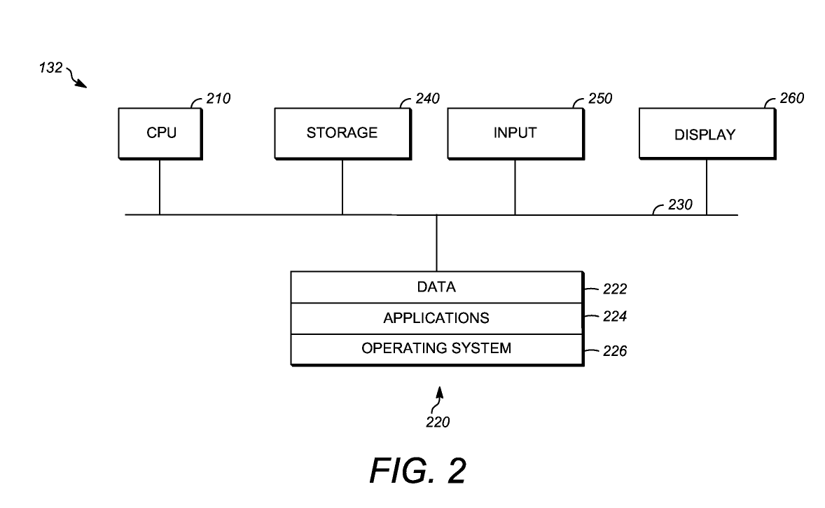

FIG. 2 is a block diagram of an example of a hardware configuration for the one or more server computers 132. The same hardware configuration or a similar hardware configuration can be used to implement the user system 110 and the additional user systems 120. Each server computer 132 can include a CPU 210. The CPU 210 can be conventional central processing units. Alternatively, the CPU 210 can be any other type of device, or multiple devices, capable of manipulating or processing information now-existing or hereafter developed. Although the disclosed examples can be practiced with a single processor as shown, e.g. CPU 210, advantages in speed and efficiency can be achieved using more than one processor.

Each server computer 132 can include memory 220, such as a random access memory device (RAM). Any other suitable type of storage device can be used as the memory 220. The memory 220 can include code and data 222 that can be accessed by the CPU 210 using a bus 230. The memory 220 can further include one or more application programs 224 and an operating system 226. The application programs 224 can include software components in the form of computer executable program instructions that cause the CPU 210 to perform the operations and methods described herein.

A storage device 240 can be optionally provided in the form of any suitable computer readable medium, such as a hard disc drive, a memory device, a flash drive or an optical drive. One or more input devices 250, such as a keyboard, a mouse, or a gesture sensitive input device, receive user inputs and can output signals or data indicative of the user inputs to the CPU 210. One or more output devices can be provided, such as a display device 260. The display device 260, such as liquid crystal display (LCD) or a cathode-ray tube (CRT), allows output to be presented to a user, for example, in response to receiving a video signal.

Although FIG. 1 depicts the CPU 210 and the memory 220 of each server computer 132 as being integrated into a single unit, other configurations can be utilized. The operations of the CPU 210 can be distributed across multiple machines (each machine having one or more of processors) which can be coupled directly or across a local area or other network. The memory 220 can be distributed across multiple machines such as network-based memory or memory in multiple machines. Although depicted here as a single bus, the bus 230 of each of each server computer 132 can be composed of multiple buses. Further, the storage device 240 can be directly coupled to the other components of the respective one of the server computers 132 or can be accessed via a network and can comprise a single integrated unit such as a memory card or multiple units such as multiple memory cards. The one or more server computers can thus be implemented in a wide variety of configurations.

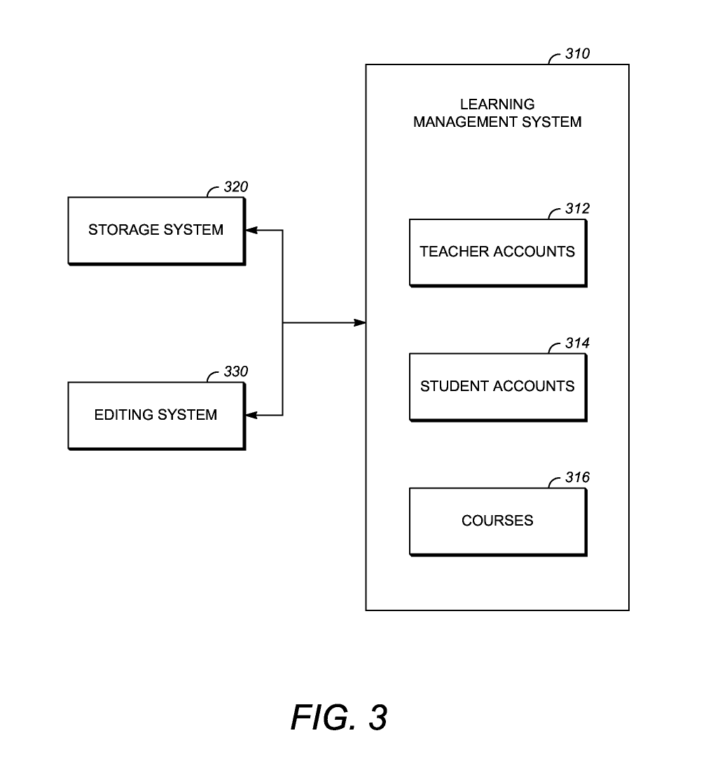

FIG. 3 is a block diagram showing components, systems, and/or services that can be executed by the application hosting service 130 including a learning management system 310 and one or more shared access systems can be in communication with the learning management system 300. In the illustrated example, the shared access systems include a storage system 320 and an editing system 330. Different or additional systems can be utilized in conjunction with the learning management system 310. Each of these systems and services can be, for example, provided in the form of software instructions that are executed by a processor or computer, such as the one or more server computers 132 of the application hosting service 130.

The storage system 320 is operable to provide a remotely accessible interface by which users can store files, access those files, and share those files with other users. The storage system 320 can provide access via, for example, a web based interface that can be output for display in the context of a web browser at a client device, such as the user system 110. The editing system 330 is a network accessible system that allows for the creation and editing of documents. As used herein, “document” refers to electronically stored information in any form, such as a computer-readable data file, which may or may not be editable by the user. Examples of documents include text files, word-processing documents, spreadsheets, notes, presentations, and illustrations. Other types of documents can be utilized with the systems and methods described herein. The editing system 330 can, in some implementations, be utilized in conjunction with the storage system 320 to obtain documents from the storage system 320 and to store documents at the storage system 320. In some implementations, the editing system 330 is accessible via a web browser based interface that can be output for display at a client device, such as at the user system 110.

The storage system 320 and the editing system 330 can be utilized in conjunction with the learning management system 310. For example, the learning management system can store objects such as documents at the storage system 320, and cause those objects to be opened for editing at the learning management system. In addition, the storage system 320 and/or the editing system 330 can include features or functions that report information to or cause actions to be taken at the learning management system 310, as will be explained further herein.

The learning management system 310 implements functions that facilitate management of a classroom environment. As one example, the learning management system 310 can implement functions that streamline the process of assigning work to students, monitoring student progress, and receiving completed work product. As another example, the learning management system can implement functions that facilitate sharing of materials, such as documents and media objects, with students. As another example, the learning management system 310 can facilitate communication between students, parents, teachers, and administrators.

The learning management system 310 can store and utilize various types of data. Some of the data stored and managed by the learning management system 310 can be associated with one or more teacher accounts 312, one or more student accounts 314, and/or one or more courses 316. The teacher accounts 312 are each associated with a teacher that is teaching a course, for example, in a classroom setting. The student accounts 314 each correspond to a particular student that is enrolled in one or more courses, for example, in a classroom setting. The courses 316 are collections of information and data relating to a course being taught by a teacher who is associated with one of the teacher accounts, and having one or more enrolled students associated with the student accounts 314. Other types of accounts and data can be maintained at the learning management system 310. For example, the learning management system 310 can implement accounts for parents of students and school administrators. As another example, a single account can be utilized for multiple roles, such as teacher and student roles.

The courses 316 are each created by a teacher who is associated with one of the teacher accounts 312. The teachers can provide and store information regarding the course 316 at the learning management system 310, such as a course name, a section or period identifier, a course description, and materials that are related to the course 316, such as a syllabus.

One or more of the student accounts 314 can be associated with the course 316. In one example, the teacher provides information to the learning management system 310 that can be utilized by the learning management system 310 to identify the student accounts 314 for students that are enrolled in the course 316, or a document such as a spreadsheet that includes information that can be utilized by the learning management system 310 to identify the student accounts 314. Information that can be utilized to identify the student accounts includes names, usernames, and email addresses. In one example, a teacher can scan a course roster document and upload the scanned course roster document to the learning management system 310, where optical character recognition techniques are utilized to extract text from the document, and the text is utilized by the learning management system 310 to identify the student accounts 314 for students that are enrolled in the course 316. In another example, information identifying the students for a course 316 can be retrieved, such as by data transmission over a network, from a data source such as an external server maintained by an educational institution that offers the course. In another example, students can choose a course 316 and associate their respective student account 314 with the course 316, such as by entering a class code that identifies the course 316.

The courses 316 can be archived, copied, and/or used as templates for creating another course. Thus, a new course 316 can be created by copying a previous course, and data associated with the previous course will then be associated with the new course, with the exception, in some implementations, of the class roster and posts and comments made by students. Posts made by the teacher and materials uploaded by the teacher can be saved as drafts that are associated with the course and can be posted at a later time by the teacher.

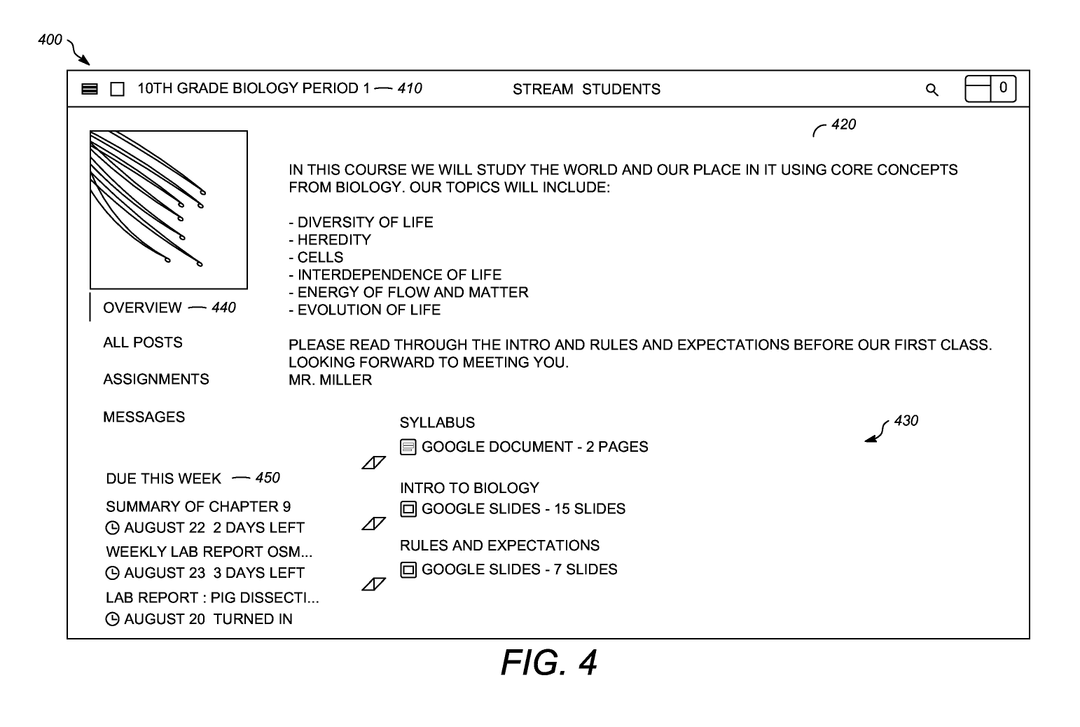

FIG. 4 shows an example of an overview interface screen 400 of the learning management system 310. In the illustrated example, the overview interface screen 400 is displayed in the context of a web browser and can be, for example, a webpage encoded in a markup language such as HTML that is transmitted from the application hosting service 130 to the user system 110 and output for display at the user system 110. In other examples, the overview interface screen 400 can be presented in a different type of application, such as a standalone application.

The overview interface screen 400 provides information regarding one of the courses 316. The information provided to the learning management system 310 regarding the course from the teacher incorporated in the overview interface screen 400, such as a course name 410, a course description 420, and links to materials 430 (in the form of documents, media items, or files) that are relevant to the course, such as a syllabus. The overview interface screen 400 can also include navigation buttons 440 for accessing other interface screens. In the illustrated example, the navigation buttons include links designated “all posts,” “assignments,” and “messages.” In the illustrated example, the overview interface screen 400 also includes an information panel 450 that displays information regarding assignments for the course, their respective due dates, and their status as being turned in or not turned in.

Teachers can utilize the learning management system 310 to create, distribute, grade, and/or return homework assignments. Assignments are created by teachers providing information and/or materials to the learning management system, or created using a pre-made template assignment. Creation of an assignment can include receiving, at the learning management system 310, information such as a title, a description, instructions, a due date, objects such as documents, media items, or other files, links to external objects, or information identifying one or more external applications that are to be used in the course of the assignment.

In one example, a teacher can create an assignment by uploading a document to the storage system 320. The document is shared with the students in the course. The students complete the assignment by opening the shared document and reading it. The storage system 320 can provided information to the learning management system regarding, for example, which students have accessed the shared document, the length of time of access, the length of time spent viewing particular portions (such as pages) of the document, and/or whether each student has completed the assignment. In this example, the teacher is the owner of the shared documents at the storage system 320, and the students are authorized to access the shared document but are not authorized to modify or delete the shared document.

In another example, a teacher can create an assignment by uploading a worksheet document to the storage system 320. During creation of the assignment, the teacher designates the worksheet document as being a template that the students will use to complete the assignment. In order to allow the students to complete the assignment, a copy of the worksheet document will be made for each student. The copy for each student can be made at the time that the assignment is created, by copying the document at that time to create a copy for each student that is enrolled in the class, where the access control information for each copy designates each student as an owner of a respective copy of the document, and optionally designates the teacher as a being authorized to access and view each copy of the document. Alternatively, the copy for each student can be made at the time that the student starts work on the assignment, such as by using an interface element included in a post regarding the assignment in the course activity stream.

In another example, a teacher can create an assignment that designates a media object at an external service, and requires that the students view the object in order to complete the assignment. The media object at the external service can be designated by, for example, a hyperlink. As one example, the media object can be a video that is hosted at an external video service. As another example, the media object can be an image. As another example, the media object can be audio content. As another example, the media object can be a document. As another example, the media object can be an online form. The external service can, such as via an API, send information to the learning management service to indicate that a specified one of the students has viewed the media object, including a duration of viewing and/or indications concerning what portion or portions of the object were viewed. The learning management system can utilize this information to determine whether the assignment should be marked as being completed with respect to the specified student. In addition, the learning management system 310 can utilize this information to provide feedback to the teacher on each student's progress. One method of implementing this would be by providing to each student a personalized link to the object, where the link causes the object to be displayed by the external service, such as by transmission over the internet, and the link contains information identifying the course and the student, where the information signifies to the external service that a report is to be transmitted to the learning management system when the student is done viewing the object, such as by using an API that is provided by the learning management system 310.

In another example, a teacher can create an assignment that causes a media object to be displayed at the learning management system 310, such as by embedding the object in an assignment post that is displayed in the course activity stream. As examples, the media object can be a video, an image, audio content, or a document. The student can view and/or interact with the object within the learning management system 310, and the learning management system can store information regarding this information as a basis for determining whether an assignment is completed. This information can be provided to the teacher.

In another example, a teacher can create an assignment from within an interface screen of the editing system 330. In this example, the editing system 330 can receive information, such as information associated with the teacher account 312, indicating that the current user is a teacher for at least one course 316 that is managed by the learning management system. In response to this information and upon determining that the current user is a teacher for at least one course, an interface screen of the editing system 330 is modified to include a user interface element that, when activated, causes an assignment to be created based on the current document. Thus, for example, the teacher can create a new document at the editing system 330 and use the functionality of the editing system 330 to prepare a worksheet for completion by students. Upon completing the worksheet, the teacher clicks on the interface element, and is presented with a dialog box that allows the currently opened document to be utilized as the basis for creating an assignment, in the same manner as described previously.

In another example, the learning management system is displayed at a device associated with a student via a web page or standalone application. An external application is also installed at the device or at a separate device that is accessible to the student. The teacher creates an assignment that requires usage of the external application. The student launches the external application via a personalized link that causes the external application to be launched, optionally causes the external application to launch specified content, and provides information to the external application that identifies the course and the student. When the student finishes using the external application, the external application can provide information to the learning management system 310, such as via an API that is provided by the learning management system 310, to report information to the learning management system regarding the student's usage of the external application. This information can include, for example, a time of usage of the application, information identifying actions taken during using of the application, such as completion of a particular lesson or other unit of content, and metrics regarding results of usage of the application, such as a score.

In some examples, the student can complete an assignment by creating a document at the editing system 330 or by opening a document at the editing system 330. The document can be a worksheet included with the assignment by the teacher, for which a copy is made with access control information (e.g. metadata) designating the student as the owner, as previously discussed. The worksheet copy can include information that identifies the worksheet copy as being associated with the assignment. Alternatively, the document can be created by the student at the document editing system. In some implementations, a document creation interface element that causes creation of a document is associated with information, such as a post in the course activity feed. When the document is created using the document creation interface element, the document can include information (e.g. metadata) that identifies the document as being related to the assignment.

When the student is finished with an assignment, such as by editing a document using the editing system 330, an interface element, such as a “turn in” button is operated by the student. In one implementation, the “turn in” button is included in a post regarding the assignment that appears in the course feed. In an alternative implementation, the “turn in” button can be incorporated in an interface screen for the editing system 330, and can be displayed as part of the interface screen for the editing system 330 in response to the information in the document that identifies the document as being related to an assignment.

After the “turn in” button is operated, the student is no longer able to modify the document. The teacher is notified that the assignment is turned in. In one example, the access control information for the document is modified to designate the teacher as the owner of the document at the storage system 320 when the document is turned in. In some implementations, the access control information for the document is also changed such that the student is no longer authorized to access the document after it is turned in. In other implementations, the access control information for the document is also changed such that the student is authorized to access the document, but is not authorized to modify the document after it is turned in.

The learning management system provides an interface by which the teacher can view turned in document, make comments regarding the turned in documents, and grade the documents. The teacher can then return the document to the student, such as by operation of an interface element. The student is notified, such as by a message. The grade for the assignment can be added by the learning management system to grading information that is maintained by the learning management system for each student. This information can be viewable by the teacher and/or the student via an interface screen. Returning the document to the student can change access control information for the document to designate the student as the owner. In some implementations, the teacher is authorized to access the document after it is returned to the student. For example, with the student re-designated as the owner of the document, the access control information can be set to grant access to the teacher to edit and/or comment on the document, which can allow continued interaction and feedback regarding the document to be exchanged between the student and the teacher.

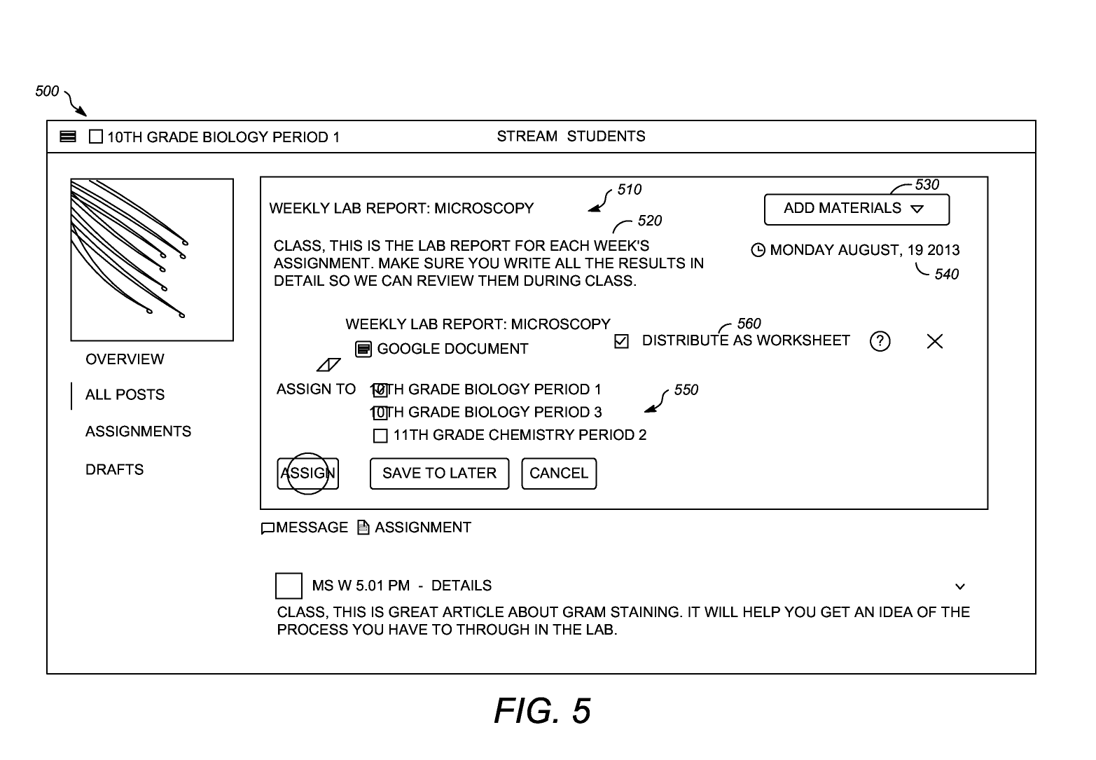

FIG. 5 is an interface screen 500 showing an example of creation of an assignment by a teacher. The interface screen includes interface elements for entering a title of the assignment 510 and instructions for the assignment 520 by text entry. The interface screen includes an interface element for adding materials 530, such as by uploading files to the storage system 320 or selecting objects that were previously stored at the storage system. The interface screen includes an interface element for setting a due date 540 for the assignment. The interface screen includes interface elements for selecting one or more courses 550 that the assignment will be made with respect to. The one or more courses can be courses that the teacher is associated with, and the assignment can be created with respect to multiple courses simultaneously. The interface screen can also include an interface element 560 for designating that an object associated with the assignment is a worksheet. As previously described, if an object is designated as a worksheet, copies of the object can be made for the students either at the time that the assignment is created, or at the time that the object is first accessed by the student.

In some implementations, each student and teacher has a storage account at the storage system 320. The storage system can store, for each user, items that are associated with courses and items that are not associated with courses. When the user views an interface of the storage system 320, the storage system determines which items, such as documents, are represented in the interface of the storage system using access control information that is associated with each object. Thus, the interface can include representation of the objects that the user is authorized to access. The user can be authorized to access an object if, based on the access control information, the user is the owner of the object, or the object is shared with the user by the owner.

In one implementation, when a user opens a document from an interface screen of the storage system 320, a determination is made as to whether that document is associated with a course that is administered by the learning management system, and the result of opening that file can be modified if the file is associated with a course. For example, a student can view an interface screen of the storage system 320 showing links to a plurality of documents, wherein at least some of the documents are associated with tasks, such as assignments made by a teacher using the learning management system 310, and at least some of the documents are not associated with tasks. The storage system receives, from a student, a request to open one of the documents at the editing system 330. The document is then output for display at the document editing system. The document editing system makes a determination as to whether or not the document is associated with a task. If the document is associated with a task, the interface screen that is output for display by the editing system 330 can include an interface element (e.g. “turn in” button) for submitting the document in response to the task. For example, if the task is an assignment made by a teacher using the learning management system 310, the document is submitted to the teacher for review and grading in response to activation of the interface element.

Activation of the interface element for submitting the document can modify the access control information that is associated with the document. For example, when the document is opened at the editing system 330, the access control information can designate the user as the owner of the document. Operation of the interface element can change the access control information for the document. For example, the access control information for the document can be changed such that the student is no longer designated as the owner of the document and the teacher is now designated as the owner of the document. After the assignment is graded, the teacher can return the graded assignment to the student. This can, in some implementations, change the access control information for the document to return ownership of the document to the student.

At the time a document is turned in responsive to an assignment and at the time the document is returned to the student after being graded, information can be stored at the storage system 320 that corresponds to the current state of the document. This information can be a “snapshot”, such as a read only backup copy of the document, a copy of the document in an format suitable for archiving (such as PDF format), or a pinned revision in a versioning-enabled file format. The information can be stored at the storage system 320 as teacher-owned documents, with the snapshots reflecting the state of assignment documents at the time that they are turned in and at the time that they are graded. Alternatively, the information can be stored separately from the storage system 320.

The learning management system 310 can provide a course activity stream that outputs information for display to teachers and students. The information in the course activity stream can describe assignments, include links to relevant content, or be informational in nature, such as by communicating, from teachers to students, information regarding upcoming event, information regarding recent events, or other information that teachers may wish to disseminate for students. The learning management system can allow students and teachers to submit comments that are associated with items in the course activity stream. In some implementations, posts in the course activity stream are all created by teachers. In other implementations, students are allowed to create posts in the course activity stream.

Objects can be embedded in posts in the course activity stream. These objects can include, for example, images, videos, and documents. Links to external objects can also be included in posts in the course activity stream.

Each assignment can be treated as a post in the course activity stream. As with other posts, posts regarding assignments can have their own list of comments, thus allowing students and teachers to submit comments that will be displayed in the course stream as part of the post regarding the assignment.

In some implementations, each stream includes posts associated with only a single course. In other implementations, a combined course stream can be output for display including posts regarding multiple courses.

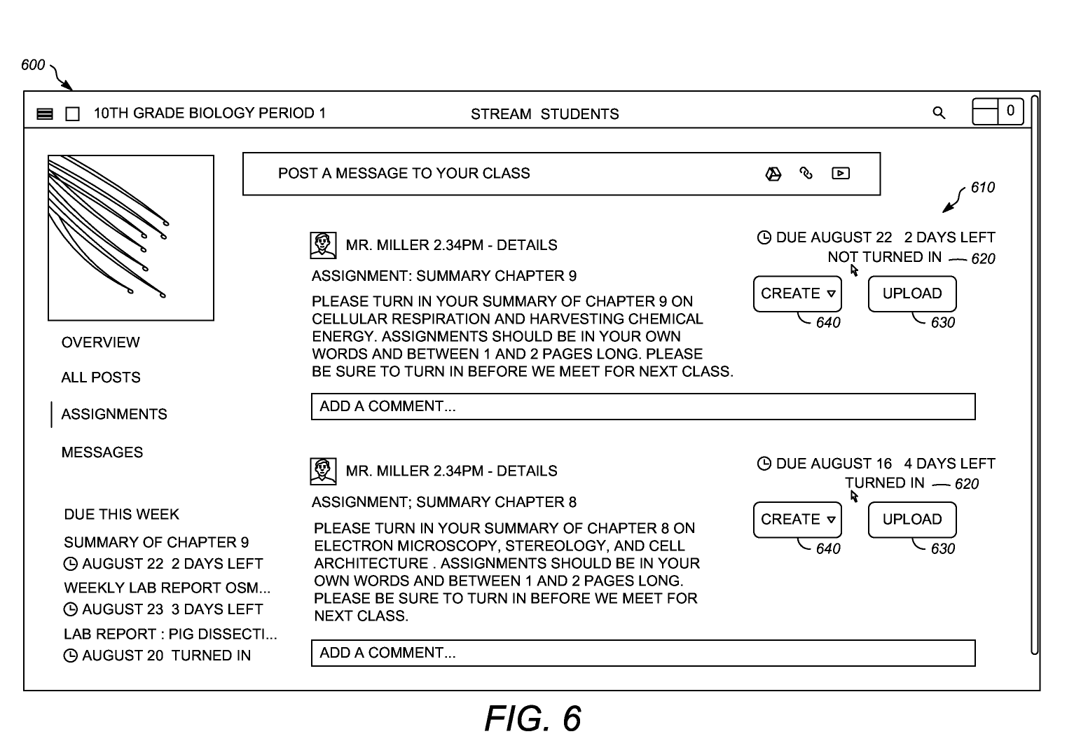

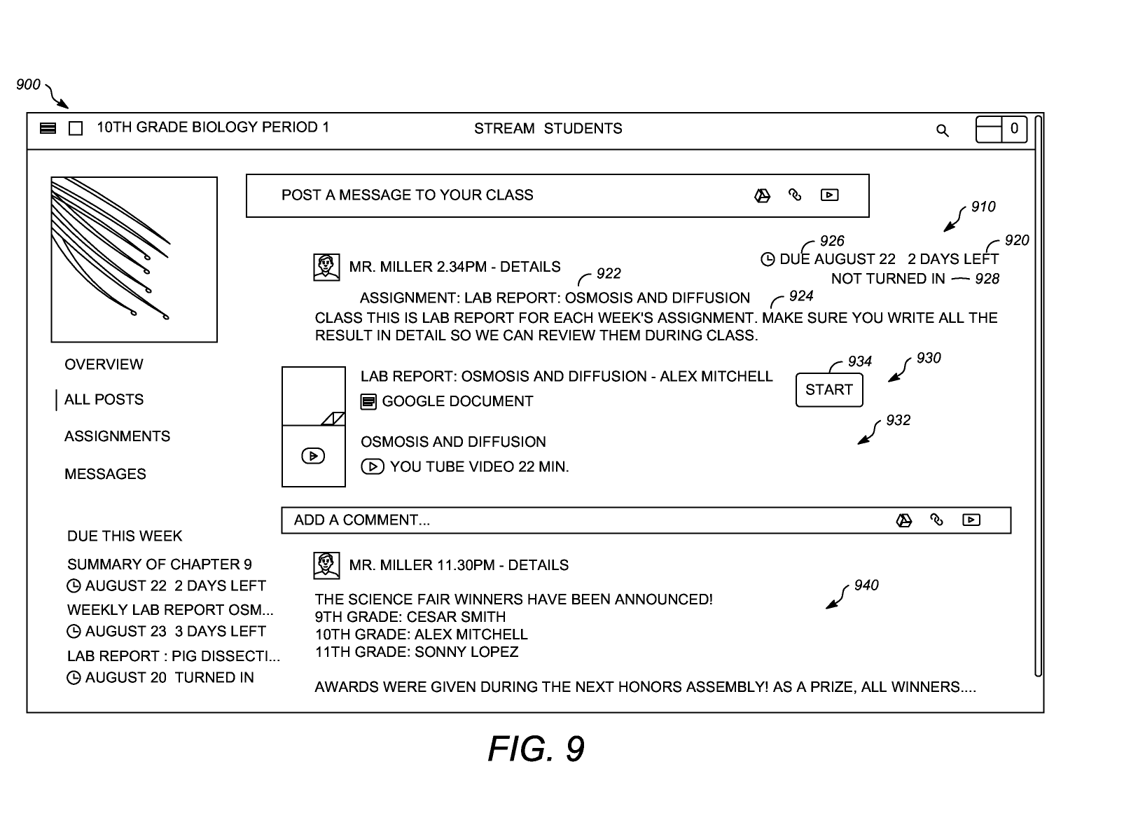

The course activity stream can be viewed in multiple formats. For example, a filtered view of the course activity stream, which is labeled “Assignments” in the illustrated examples, can display only assignments, such as in the interface screen 600 of FIG. 6. Posts of all types including assignments and other information can be output for display in an unfiltered view of the course activity stream, which is labeled “All Posts” in the illustrated example, such as in the interface screen 900 of FIG. 9.

In addition to posts in the course activity stream, other types of notifications can be provided to users. As one example, certain posts such as assignment posts can trigger notifications that are sent to students by a second communication channel such as by email. As another example, submission of an assignment from a student to a teacher can trigger sending of a notification email to the teacher.

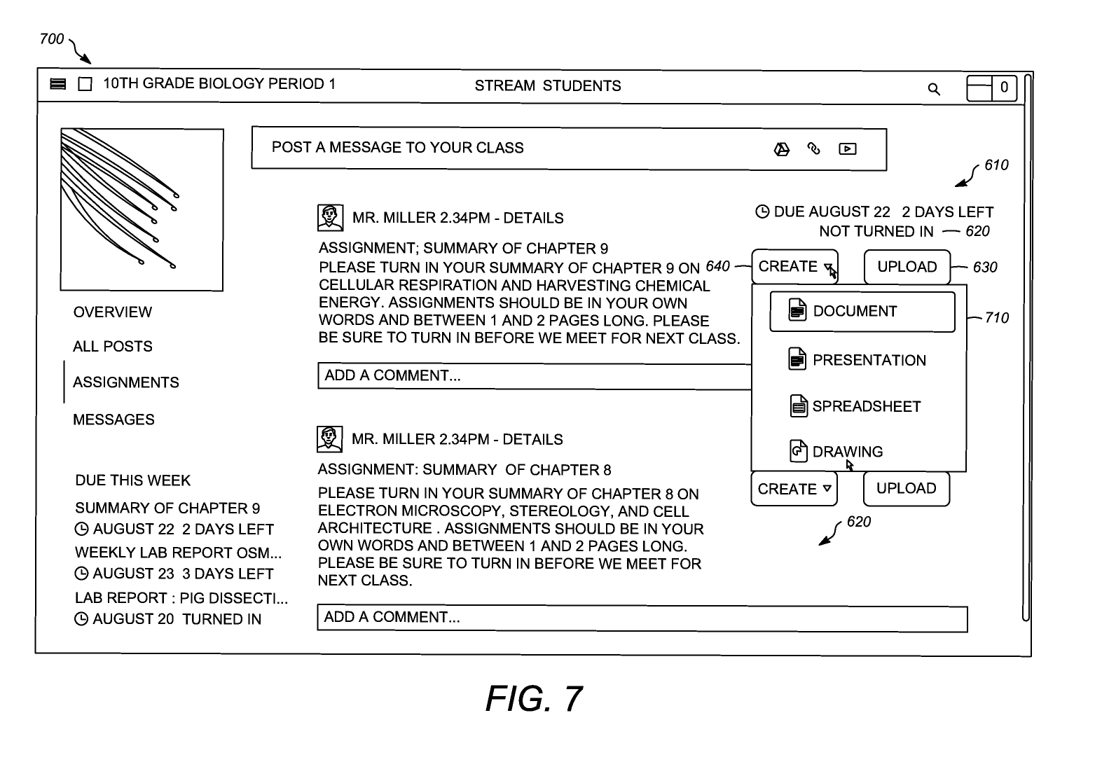

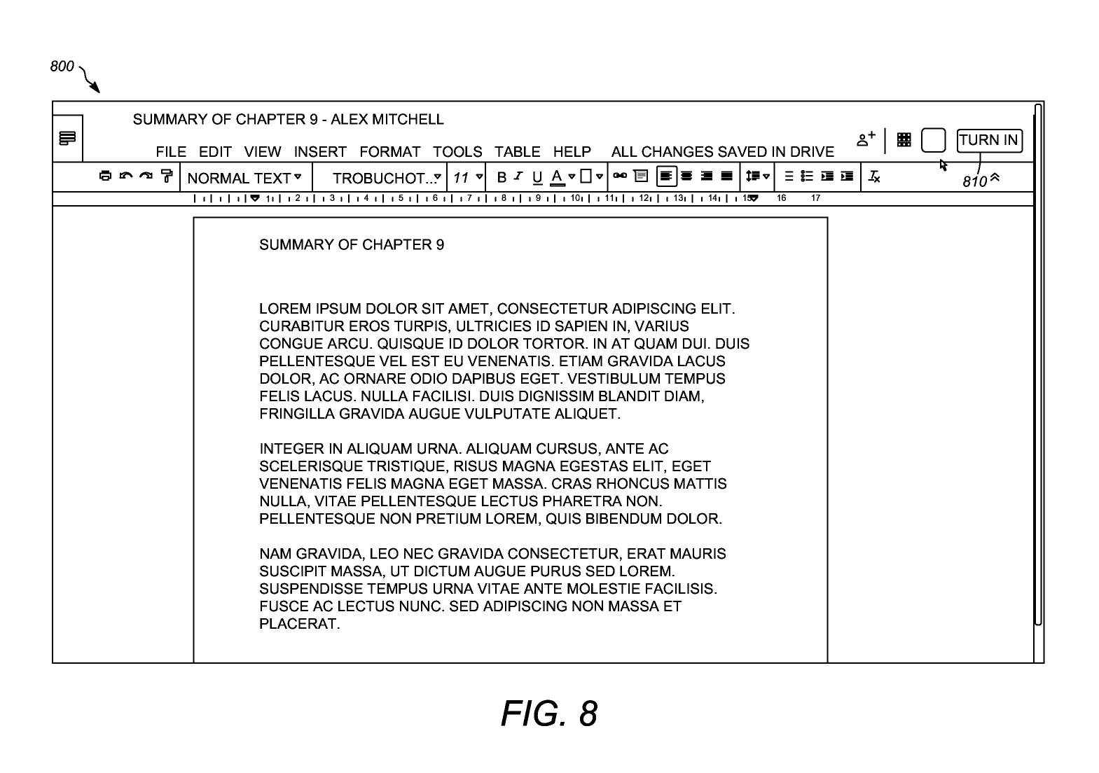

FIG. 6 shows an interface screen 600 of the learning management system 310. The interface screen 600 includes a course activity feed 610 for assignments, and includes multiple posts 620 that each include information regarding a respective assignment. The posts regarding assignments each include one or more interface elements that allow students to work on an assignment or upload a completed assignment. In the illustrated example, each assignment post includes an upload interface element 630 for uploading a document to the storage system 320 and simultaneously submitting that document for grading by the teacher. Each assignment post also includes a create interface element 640. Activation of the create interface element 640 outputs, for display to the user, a menu 710 that allows the user to select a document type to create, as shown in an interface screen 700 of FIG. 7. In the illustrated example, the student can select from multiple document types, including a word processing document, a presentation document, a spreadsheet document, and a drawing document. In response to this selection, the selected type of document is created at the storage system 320 with the student being identified as the owner in the access control information for the document, and information (metadata) is stored at the storage system 320 that associates the document with the course and the assignment for which it was created. By associating the document with the assignment, an interface element 810 can be output for display by the editing system 330 during editing of the document, as shown in the interface screen 800 of FIG. 8. Activation of this interface element 810 submits the document to the teacher for review and/or grading, and information is transmitted to the learning management system that indicates that work product has been turned in for this assignment, which changes the state of this assignment for this student to the “turned in” state at the learning management system 310.

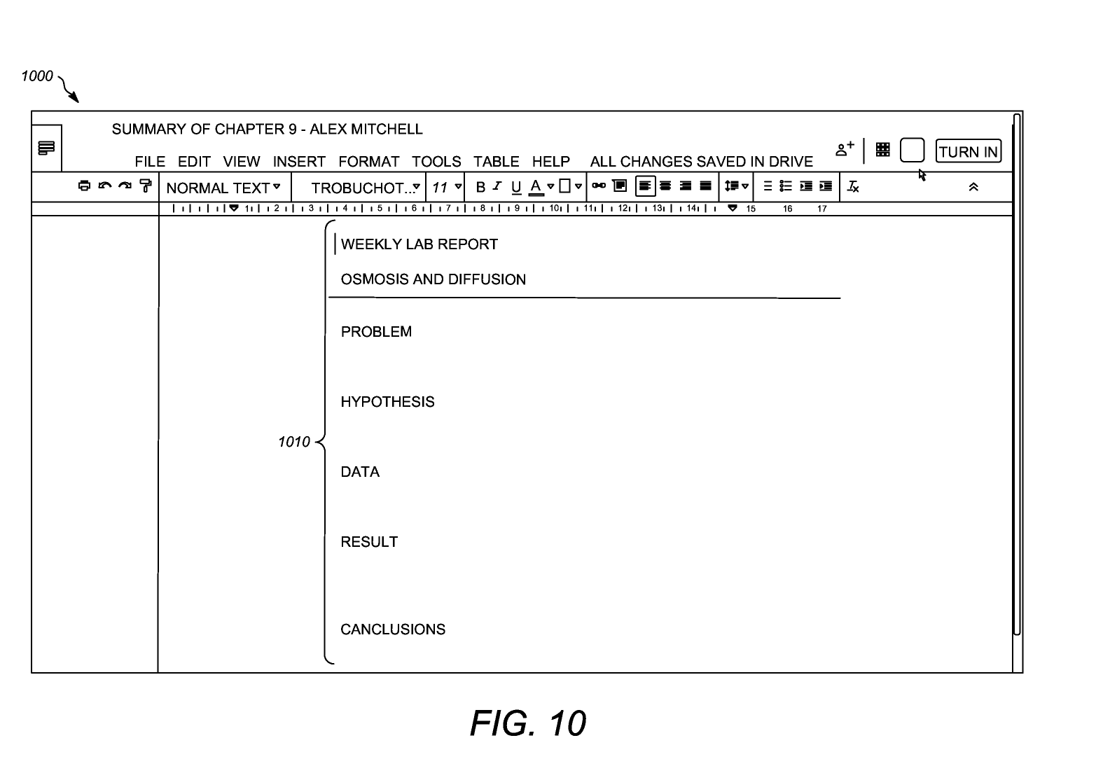

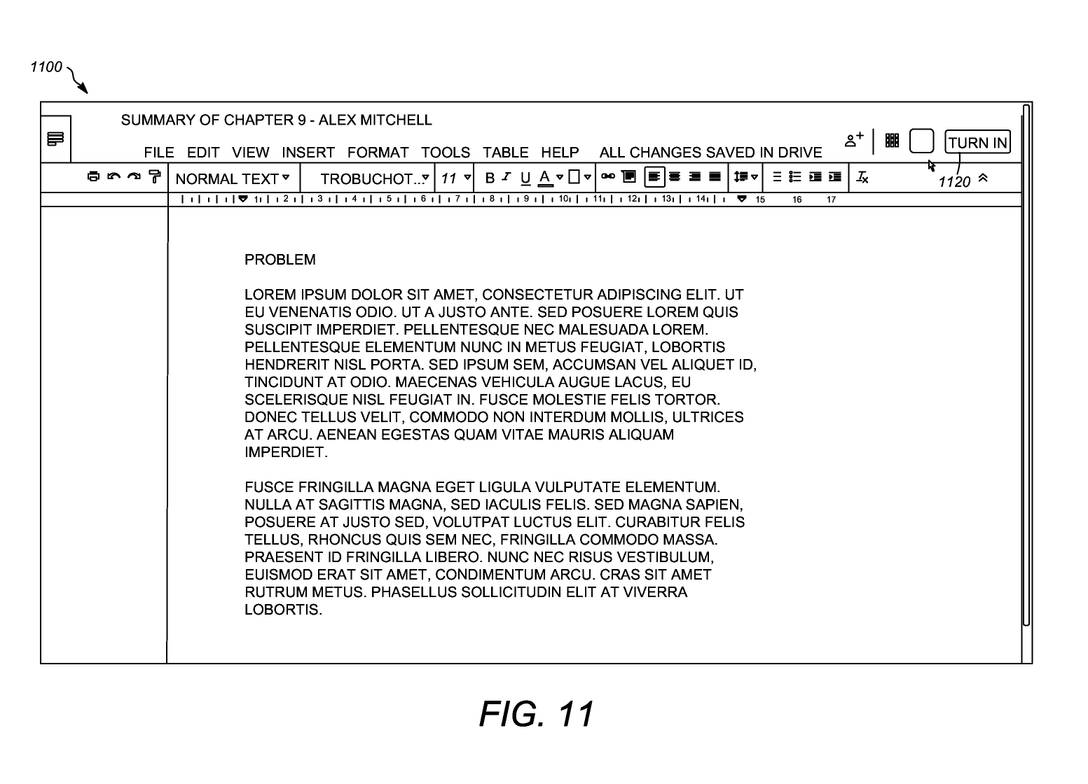

FIG. 9 shows an interface screen 900 that can be output for display by the learning management system 310. The interface screen 900 includes an “all posts” course activity stream 910 and displays a first post, which is an assignment post 920, and a second post, which is an informational post 940. The assignment post includes information identifying an assignment 922, information giving instructions for the assignment 924, a due date 926, and a status 928 for the assignment that indicates that the assignment has not yet been turned in by the student that is viewing the post. The assignment post 920 includes materials that are related to the assignment including a worksheet 930 and a link to a media object 932, which in this example is a video that is hosted at an external video hosting service. A start button 934 allows the student to open a copy of the worksheet for editing at the editing system 330, as shown in the interface screen 1000 of FIG. 10. The copy of the document stored at the storage system 320, is owned by the student, and can be created either at the time that the assignment is created by the teacher, or at the time that the start button is activated by the student. Initially, when the document is opened for editing using the editing system 330, pre-existing worksheet material 1010 is included in the document, as was included in the template from which the copy of the document was made. In the illustrated example, the document is a worksheet, and pre-existing headings are included in the document, which in this case is a weekly lab report regarding the topic of “Osmosis and Diffusion.” In the interface screen 1100 of FIG. 11, the student has added information 1110 to the document using the editing system 330. The editing system 330 has identified the document as being related to a course and an assignment, and a “turn in” interface element 1120 is displayed in the interface screen 1100. Activation of the turn in interface element 1120 notifies the teacher of the course that the student has completed the assignment, submits the assignment for grading, and changes information at the learning management system 310 to change the status of this assignment for this student to “turned in.”

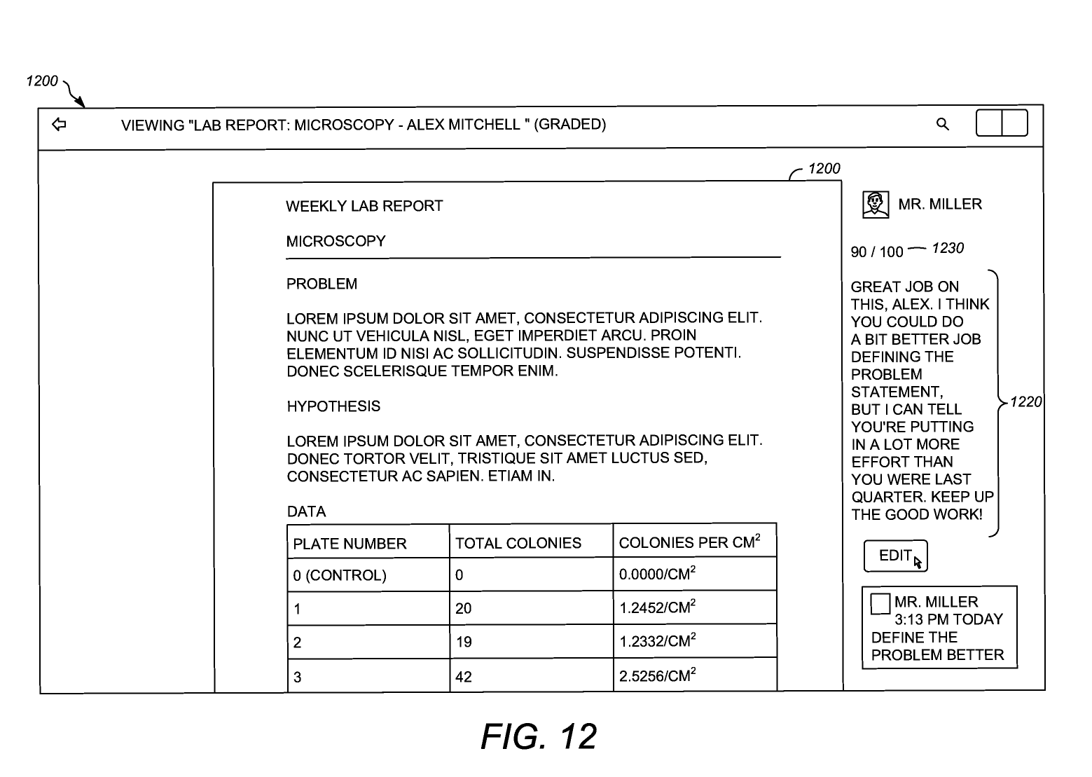

After the student turns in the assignment, the teacher receives the notification regarding completion of the assignment, can view the copy of the document at an interface for grading the document, and can add grading information to the copy of the document via at least one interface element of the interface for grading the document. The grading information can include, for example, comments and or a grade (score) for the assignment. The teacher then uses the learning management system to indicate that grading of the assignment is complete, such as by operating an interface element for returning the assignment, and the copy of the document is returned to the student, such as by changing access control information for the document to indicate that the student is the owner of the document again. When the student opens the graded copy of the document, an interface screen 1200 can be output for display to the student as shown in FIG. 12. The interface screen 1200 can include a view of the document 1210, the teacher's comments 1220, and the grade 1230 given to the student by the teacher for the assignment.

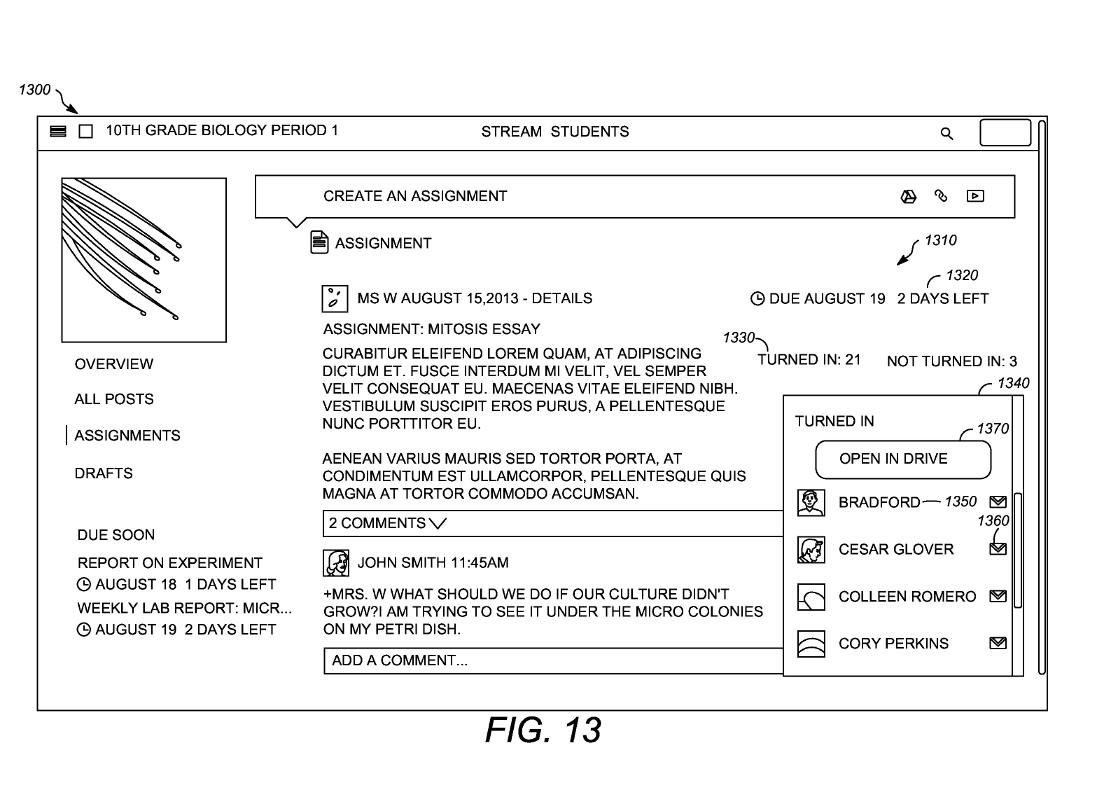

FIG. 13 shows an interface screen 1300, which can be output for display to a teacher associated with a teacher user account. In the interface screen 1300, a course stream 1310 includes a post 1320 related to an assignment. Information is included in the post that identifies the number of students that have turned the assignment in. Clicking on an interface element 1330 shows a pop-up box 1340 containing information as to which students have and have not turned in the assignment, links to the documents turned in by the students 1350, and links to email students 1360. A link 1370 can be included for opening a folder at the storage system 320 that corresponds to the assignment and contains the documents turned in by the students.

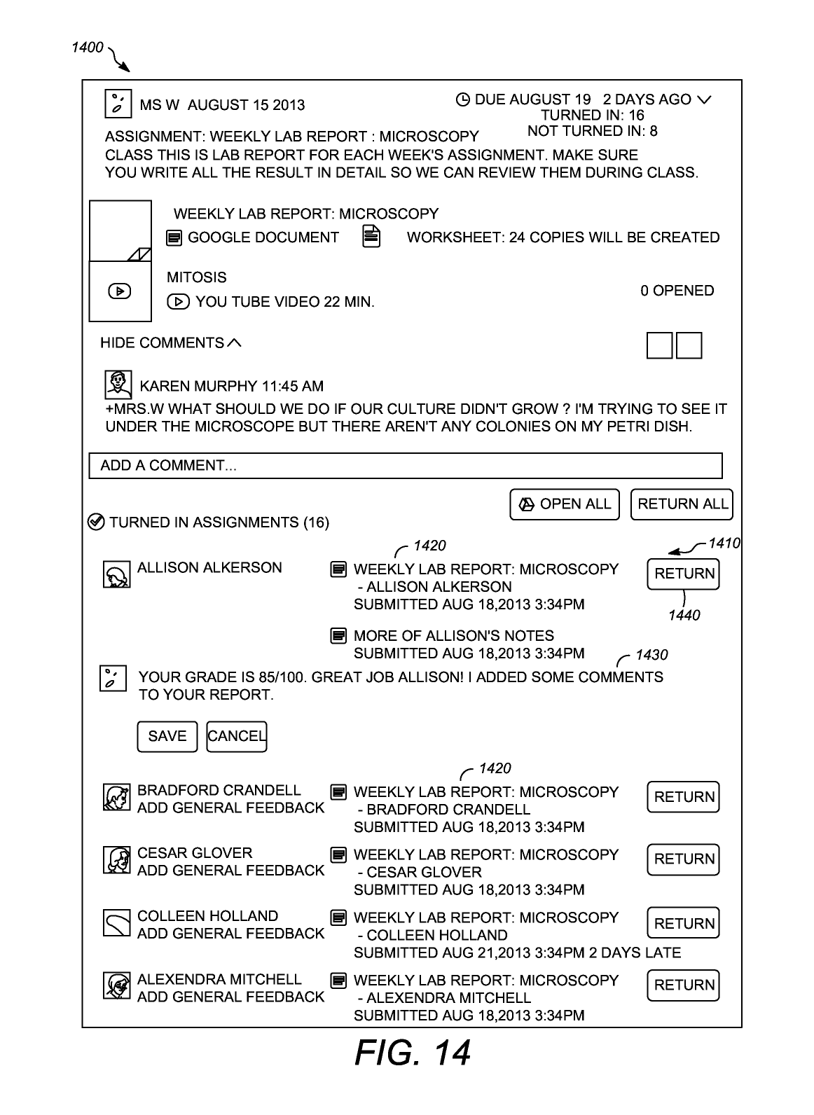

FIG. 14 shows an interface screen 1400, which includes a detailed view regarding a particular assignment. The interface screen 1400 includes a list 1410 of all students who turned in the assignment, with interface elements 1420 for opening the turned in documents, for adding feedback 1430 that will be transmitted to the student as a message when the assignment is returned, and for returning the assignment to the student 1440, which can include returning a copy of the turned in document that includes comments or other markings made by the teacher. Returning the assignment to the student can change access control information at the storage system 320 for the documents associated with the assignment, such that the student becomes the owner of the documents.

Other types of interface screens can be provided by the learning management system. As one example, a home view can display, for a student or a teacher or others, all of the courses that they are associated with. The home view can include information regarding each course, such as snippets of one or two items from the course activity stream, information describing assignments that will be due soon, and/or photographs that are associated with each course. As another example, every course can have associated with it a teacher-owned calendar. Assignment due dates can be automatically added to the calendar. Students that are enrolled in a course can automatically be authorized to view the calendar items that are associated with that course, and those items can be syndicated to a calendar that is owned by each student.

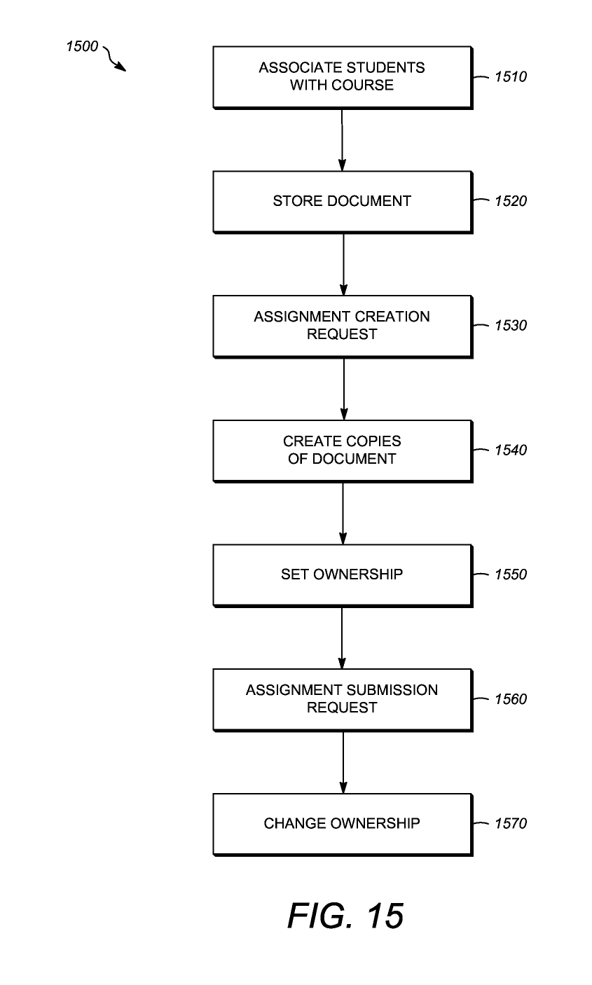

FIG. 15 is a flow chart showing a process 1500 for learning management that can be implemented by the learning management system 310. The operations described in connection with the process 1500 can be performed at one or more computers, such as at the one or more server computers 132 of the application hosting service 130. When an operation is performed by one or more computers, it is completed when it is performed by one computer. The operations described in connection with the process 1500 can be embodied as a non-transitory computer readable storage medium including program instructions executable by one or more processors that, when executed, cause the one or more processors to perform the operations. For example, the operations described in connection with the process 1500 could be stored at the memory 220 of a respective one of the server computers 132 and be executable by the CPU 210 thereof.

At operation 1510, students are associated with a course. The students can be associated with student accounts and the course can be associated with a course identifier. At operation 1520, a document is stored. For example, a document can be stored at the storage system 320. At operation 1530, an assignment creation request is received. The assignment creation request can be received based on information submitted to the learning management system 310 by a teacher, for example, as described with respect to the interface screen 500. Subsequent to the assignment creation request, copies of the document are created at operation 1540, each being associated with a respective student, where the student can be made the owner of the document. The copies of the document can be made in response to the assignment creation request, at the time of the assignment creation request. Alternatively, copies of the document can be made in response to each student initiating work on the assignment. An ownership parameter for each of the copies of the document can be set to reference a respective student user account from the plurality of student user accounts at operation 1550. Information associated with each copy of the document can refer to the course and the assignment, for example, so that the storage system 320 and the editing system 330 can include interface elements specific to the assignment, such as an interface element for turning in the assignment. Notifications can be sent to each student, for example, via a course activity feed or by email. The student can prepare a work product object that is stored at the storage system 320, such as a document for the assignment, and when completed, activate an interface element to turn in the work product object at operation 1560. Activation of the interface element can change ownership information associated with work product object at the storage system at operation 1570, and a notification can be sent to the teacher.

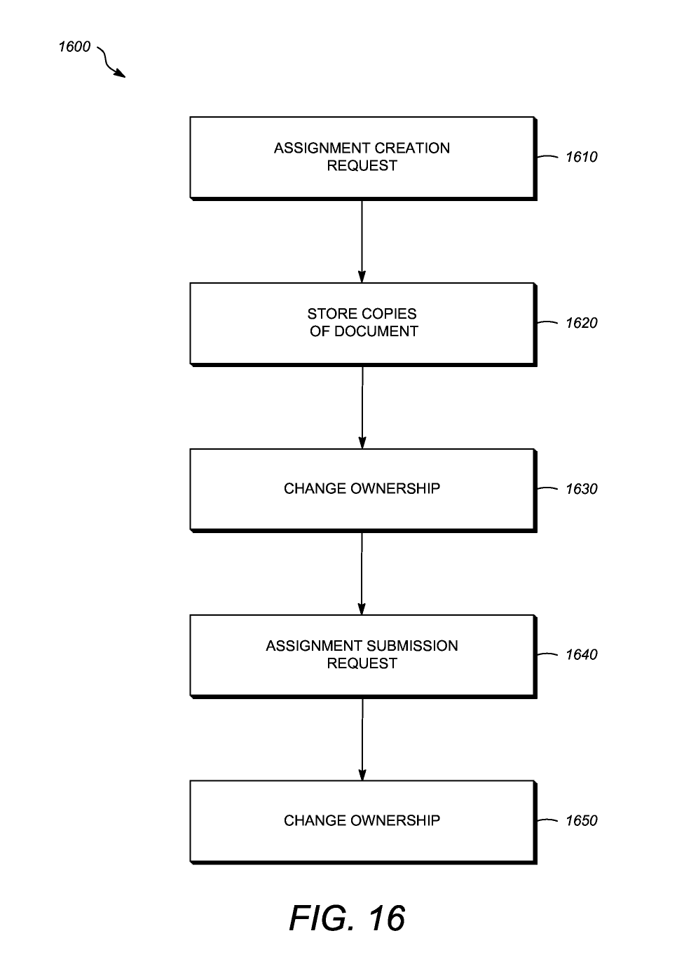

FIG. 16 is a flow chart showing a process 1600 for learning management that can be implemented by the learning management system 310. The operations described in connection with the process 1600 can be performed at one or more computers, such as at the one or more server computers 132 of the application hosting service 130. When an operation is performed by one or more computers, it is completed when it is performed by one computer. The operations described in connection with the process 1600 can be embodied as a non-transitory computer readable storage medium including program instructions executable by one or more processors that, when executed, cause the one or more processors to perform the operations. For example, the operations described in connection with the process 1600 could be stored at the memory 220 of a respective one of the server computers 132 and be executable by the CPU 210 thereof.

At operation 1610, an assignment creation request is received from a teacher user account, wherein the assignment creation request identifies a document that is stored at a storage system and identifies a plurality of student user accounts. At operation 1620, at the storage system, a respective copy of the document is stored for each student user account. At operation 1630, an ownership parameter for each respective copy of the document references a respective student user account from the plurality of student user accounts. In response to receiving an assignment submission request at operation 1640 from a first student user account from the plurality of student user accounts regarding the respective copy of the document for the first student user account, at operation 1650, an ownership parameter for the first copy of the document is set to reference the teacher user account.

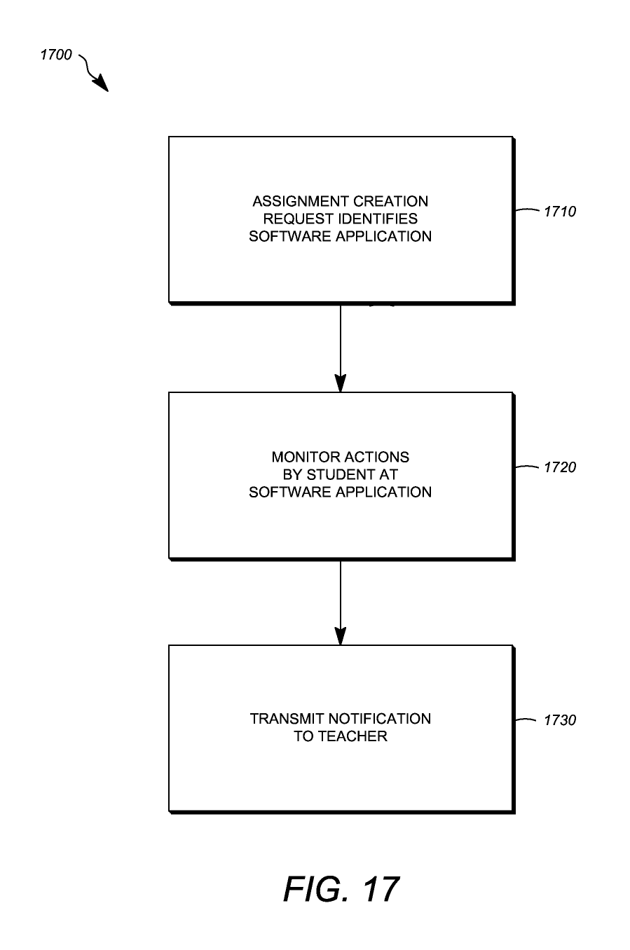

FIG. 17 is a flow chart showing a process 1700 for learning management that can be implemented by the learning management system 310. The operations described in connection with the process 1700 can be performed at one or more computers, such as at the one or more server computers 132 of the application hosting service 130. When an operation is performed by one or more computers, it is completed when it is performed by one computer. The operations described in connection with the process 1700 can be embodied as a non-transitory computer readable storage medium including program instructions executable by one or more processors that, when executed, cause the one or more processors to perform the operations. For example, the operations described in connection with the process 1700 could be stored at the memory 220 of a respective one of the server computers 132 and be executable by the CPU 210 thereof.

Operation 1710 includes receiving an assignment creation request from a teacher user account, wherein the assignment creation request identifies an object. The object can be a document, a media object, or a software application, which can be an external software application, as previously described. Operation 1720 includes monitoring one or more actions taken by each student user account with respect to the object. Operation 1730 includes transmitting information, such as a notification, to the teacher user account, wherein the notification relates to at least one action from the one or more actions and at least one student account from the plurality of student accounts.

As an example, in the process 1700, the teacher can assign a video. The student accesses the video using an interface element, such as a link, that is included in a post regarding the assignment that is included in the course activity stream. The student views the video and information regarding the student viewing the video is transmitted to the teacher. The transmission can be made, for example, by a service hosting the video using an API that is provided by the learning management system 310. Thus, the teacher can be provided information as to whether the student watched the entire video.

As an example, in the process 1700, the teacher can assign usage of a software application. The student accesses the software application using an interface element, such as a link, that is included in a post regarding the assignment that is included in the course activity stream. The student uses the software application and information regarding the student's use of the software application is transmitted to the teacher. For example, the software application can be a mathematics review game, and the teacher can be provided information such as a score achieved by the student or an assessment as to the student's competency with respect to specific concepts.

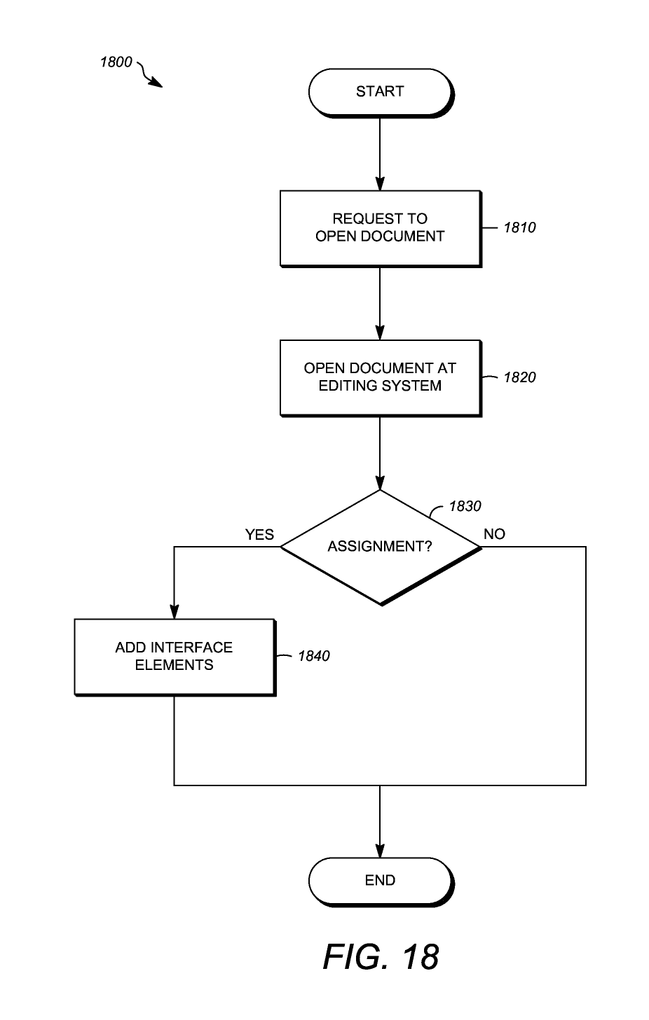

FIG. 18 is a flow chart showing a process 1800 for learning management that can be implemented by the learning management system 310. The operations described in connection with the process 1800 can be performed at one or more computers, such as at the one or more server computers 132 of the application hosting service 130. When an operation is performed by one or more computers, it is completed when it is performed by one computer. The operations described in connection with the process 1800 can be embodied as a non-transitory computer readable storage medium including program instructions executable by one or more processors that, when executed, cause the one or more processors to perform the operations. For example, the operations described in connection with the process 1800 could be stored at the memory 220 of a respective one of the server computers 132 and be executable by the CPU 210 thereof.

Operation 1810 includes receiving, from a first user such as a student, a request to open a document at a document editing system. Operation 1820 includes outputting, for display, the document by the document editing system. Operation 1830 includes determining whether the document is associated with at least one task assigned by at least one other user, such as a teacher. The at least one task can be an assignment that is associated with a course at the learning management system 310. If the document is associated with the at least one task assigned by the at least one other user, operation 1840 includes outputting for display with the document, an interface element that, when activated by the first user, causes a notification regarding the document to be sent to the second user. The interface element is not displayed if the document is not associated with the at least one task assigned by the at least one other user. The request to open the document can originate from an interface screen of a shared storage system showing links to a plurality of documents, wherein at least some of the documents are associated with tasks and at least some of the documents are not associated with tasks. The at least one task is associated with an assignment created by a teacher using the learning management system 310. The at least one other user can be a teacher and activation of the interface element can submit the document to the teacher for grading. Activation of the interface element changes access control information associated with the document. The access control information identifies the first user as the owner of the document prior to activation of the interface element and the access control information identifies the at least one other user as the owner of the document subsequent to activation of the interface element.

In the examples given above, assignments are described as being completed by a single student and being graded by a single teacher. It should be understood, however, that multiple students could work collaboratively on a single assignment, and/or multiple teachers could collaboratively grade a single assignment. In these situations, the access control information could designate multiple students as co-owners of a document, and then change ownership to designate multiple teachers as co-owners of the document. In another implementation, the access control information could designate a primary owner of the document (e.g. a student, a teacher, a system account), and add collaborators (e.g. other students) as editors.

The foregoing description describes only some exemplary implementations of the described techniques. Other implementations are available. For example, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such.

The implementations of the computer devices (e.g., clients and servers) described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of each of the clients and each of the servers described herein do not necessarily have to be implemented in the same manner.

Operations that are described as being performed by a single processor, computer, or device can be distributed across a number of different processors, computers or devices. Similarly, operations that are described as being performed by different processors, computers, or devices can, in some cases, be performed by a single processor, computer or device.

Although features may be described above or claimed as acting in certain combinations, one or more features of a combination can in some cases be excised from the combination, and the combination may be directed to a sub-combination or variation of a sub-combination.

The systems described herein, such as client computers and server computers, can be implemented using general purpose computers/processors with a computer program that, when executed, carries out any of the respective methods, algorithms and/or instructions described herein. In addition or alternatively, for example, special purpose computers/processors can be utilized which can contain specialized hardware for carrying out any of the methods, algorithms, or instructions described herein.

Some portions of above description include disclosure presented in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality. It should be noted that the process steps and instructions of implementations of this disclosure could be embodied in software, firmware or hardware, and when embodied in software, could be downloaded to reside on and be operated from different platforms used by real time network operating systems.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

At least one implementation of this disclosure relates to an apparatus for performing the operations herein. This apparatus may be specially constructed for the required purposes, or it may comprise a general-purpose computer selectively activated or reconfigured by a computer program stored on a computer readable storage medium that can be accessed by the computer.

All or a portion of the embodiments of the disclosure can take the form of a computer program product accessible from, for example, a non-transitory computer-usable or computer-readable medium. The computer program, when executed, can carry out any of the respective techniques, algorithms and/or instructions described herein. A non-transitory computer-usable or computer-readable medium can be any device that can, for example, tangibly contain, store, communicate, or transport the program for use by or in connection with any processor. The non-transitory medium can be, for example, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for tangibly containing, storing, communicating, or transporting electronic instructions.

It is to be understood that the disclosure is not to be limited to the disclosed embodiments but, on the contrary, is intended to cover various modifications and equivalent arrangements included within the spirit and scope of the appended claims.

What is claimed is:

1. A method comprising:
receiving, at one or more server computers, an assignment creation request from a leader user account, wherein the assignment creation request identifies a document that is stored at a storage system, identifies a plurality of participant user accounts, and causes creation of an assignment at the one or more server computers; and
storing, at the storage system, a respective copy of the document for each participant user account, wherein an ownership parameter for each respective copy of the document references a respective participant user account from the plurality of participant user accounts.

2. The method of claim 1, further comprising:
subsequent to storing the respective copy of the document for each participant user account, transmitting a notification to each user account from the plurality of participant user accounts, the notification identifying the respective copy of the document.

3. The method of claim 1, further comprising:
in response to receiving an assignment submission request from a first participant user account from the plurality of participant user accounts regarding the respective copy of the document for the first participant user account, setting the ownership parameter for the respective copy of the document to reference the leader user account.

4. The method of claim 3, further comprising:
outputting, for display with respect to the leader user account subsequent to setting the ownership parameter for the respective copy of the document to reference the leader user account, an interface for grading the respective copy of the document.

5. The method of claim 4, wherein the interface for grading the respective copy of the document includes at least one interface element for adding grading information to the copy of the document.

6. The method of claim 5, wherein the grading information includes at least one of comments for the assignment or a score for the assignment.

7. The method of claim 5, wherein the interface for grading the respective copy of the document includes an interface element for returning the respective copy of the document which, when activated, changes the ownership parameter for the respective copy of the document to reference the respective participant user account.

8. A method comprising:
receiving, at one or more server computers, an assignment creation request from a leader user account, wherein the assignment creation request identifies an object and causes creation of an assignment at the one or more server computers;
monitoring, by the one or more server computers, one or more actions taken by each participant user account from a plurality of participant user accounts with respect to the object; and
transmitting, by the one or more server computers, a notification to the leader user account, wherein the notification relates to at least one action from the one or more actions and at least one participant account from the plurality of participant accounts.

9. The method of claim 8, wherein the notification identifies, with respect to at least one participant account from the plurality of participant accounts, whether the object has been accessed.

10. The method of claim 8, wherein the notification identifies, with respect to at least one participant account from the plurality of participant accounts, whether the assignment has been completed.

11. The method of claim 8, wherein the object is a document.

12. The method of claim 8, wherein the object is a media object.

13. The method of claim 8, wherein the object is a software application.

14. A method comprising:
receiving, from a first user, a request to open a document at a document editing system;
outputting, for display, the document by the documents editing system;
determining whether the document is associated with at least one task assigned by at least one other user; and
if the document is associated with the at least one task assigned by the at least one other user, outputting for display with the document, an interface element that, when activated by the first user, causes a notification regarding the document to be sent to the at least one other user.

15. The method of claim 14, wherein the interface element is not displayed if the document is not associated with the at least one task assigned by the at least one other user.

16. The method of claim 14, wherein the request to open the document originates from an interface screen of a shared storage system showing links to a plurality of documents, wherein at least some of the documents are associated with tasks and at least some of the documents are not associated with tasks.

17. The method of claim 14, wherein the at least one task is associated with an assignment created by a teacher using a learning management system.

18. The method of claim 14, wherein the at least one other user is a teacher and activation of the interface element submits the document to the teacher for grading.

19. The method of claim 14, wherein activation of the interface element changes access control information associated with the document.

20. The method of claim 19, wherein the access control information identifies the first user as an owner of the document prior to activation of the interface element and the access control information identifies the at least one other user as the owner of an owner document subsequent to activation of the interface element.
